(19) United States
(12) Patent Application Publication
(10) Pub. No.: US 2011/0051266 A1
(43) Pub. Date: Mar. 3, 2011

(54) COVECTED-SHAPED EDGE REAR VIEW MIRROR AND METHOD OF USE

(76) Inventor: Chad Porter VICKREY, Winters, CA (US)

(21) Appl. No.: 12/868,632

(22) Filed: Aug. 25, 2010

Related U.S. Application Data
(60) Provisional application No. 61/237,053, filed on Aug. 26, 2009.

(51) Int. Cl. G02B 5/08

(52) U.S. Cl. 359/843; 359/850

(57) ABSTRACT

The present invention is a rear view mirror provided on a vehicle with a flat glass reflective panel section, a plurality of convect-shaped curved outer and lower edges disposed onto flat glass reflective panel section that provide a clear view to a rear side of a vehicle, into a blind spot and also at ground level and a convect-shaped edge rear view mirror housing that is fitted with said flat-glass reflective panel section that is curved forward along the curved outer and lower edges. The rear view mirror can also be provided as a complete rear view mirror replacement on an aftermarket vehicle. There is also a method of using a convected-shape edge rear view mirror as well.

This application claims priority to U.S. Provisional Application 61/237,053 filed on Aug. 26, 2009, the entire disclosure of which is incorporated by reference.

### TECHNICAL FIELD & BACKGROUND

The present invention generally relates to an improved rear view mirror and method of use. More specifically, the invention is a convected-shaped edge rear view mirror and method of use.

It is an object of the invention to provide an external mirror for vehicles designed to provide a clear view to the rear side, into a blind spot and also at ground level.

It is an object of the invention to improve a driver's ability to see into the adjacent lane and prevent unnecessary sideswiping accidents from occurring.

It is an object of the invention to provide a mirror that is especially useful when changing lanes and merging into busy traffic on highways and other roadways.

It is an object of the invention to provide a convected-shaped edge rear view mirror and method of use that is useful when parking next to curbs by providing a downward view at the side of an attached vehicle.

What is really needed is a convected-shaped edge rear view mirror and method of use that provides an external mirror for a vehicle designed to provide a clear view to the rear side of the vehicle, into a blind spot and also at ground level that improves a driver's ability to see into an adjacent lane and prevent unnecessary sideswiping accidents from occurring and that is especially useful when changing lanes and merging into busy traffic on highways and other roadways.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates an overhead perspective view of a plurality of convected-shaped edge rear view mirrors, in accordance with one embodiment of the present invention.

FIG. 1B illustrates a side perspective view of a convected-shaped edge rear view mirror, in accordance with one embodiment of the present invention.

FIG. 1C illustrates an overhead perspective view of a generally rectangular convected-shaped edge rear view mirror, in accordance with one embodiment of the present invention.

FIG. 2 illustrates steps of a method of using a convected-shaped edge rear view mirror, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

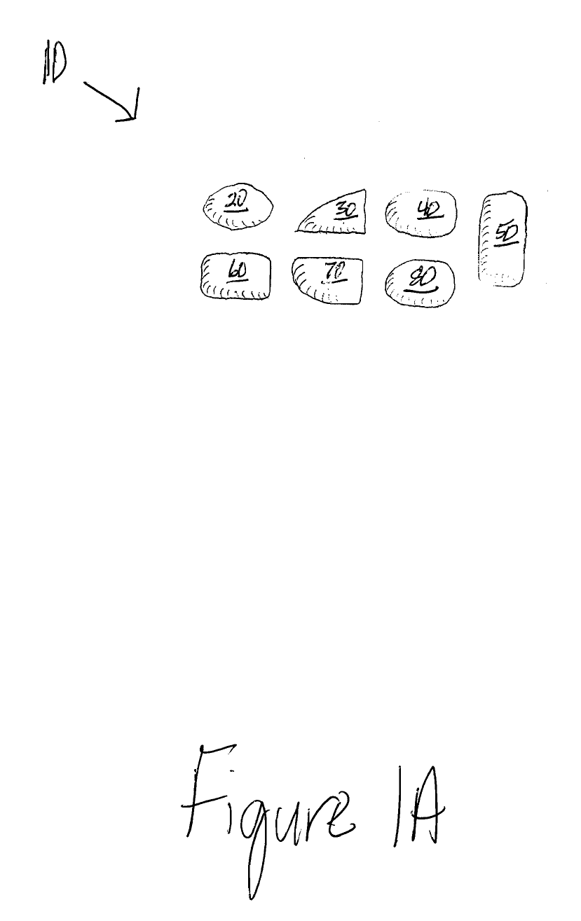

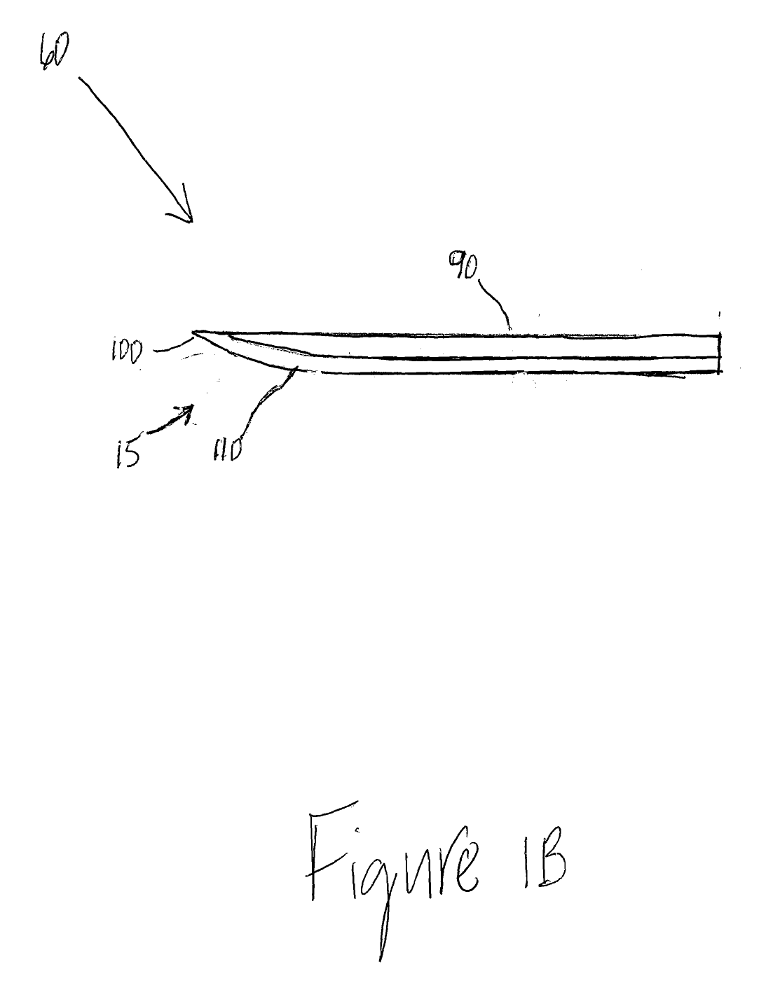

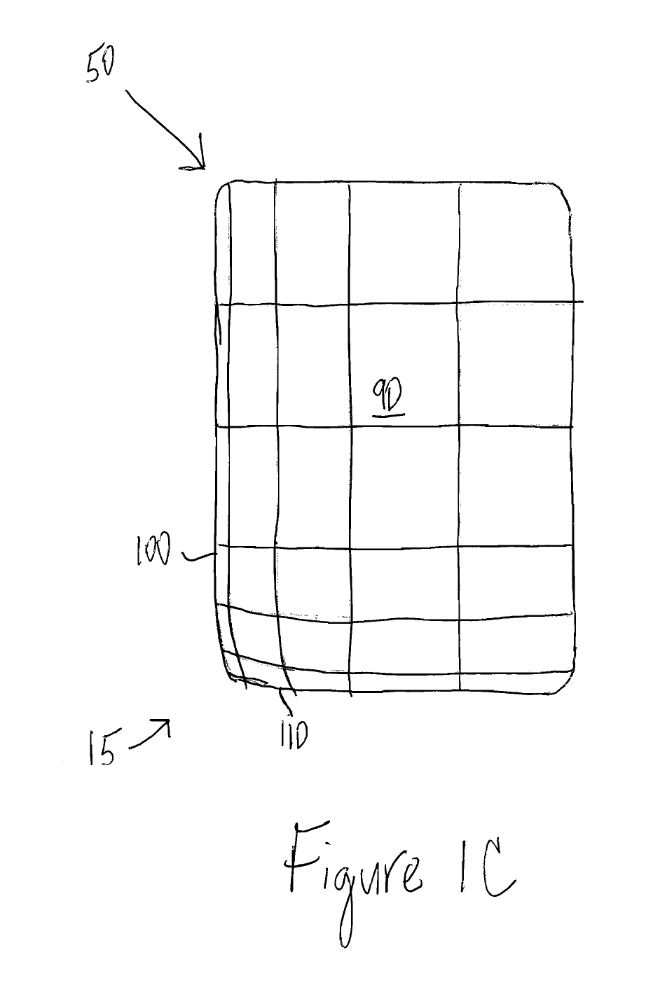

FIG. 1A illustrates an overhead perspective view of a plurality of convected-shaped edge rear view mirrors 10. Each individual convected-shaped edge rear view mirror represents an embodiment of the convected-shaped edge rear view mirror 10. All of the individual convected-shaped edge rear view mirrors are provided with curved outer and lower edges 15, as are discussed in greater detail in FIG. 1B and FIG. 1C. The plurality of convected-shaped edge rear view mirrors 10 include a general oval shape 20, a triangle with a right angle and curved hypotenuse shape 30, an oval shape with a rounded off side 40, an upright vertical rectangular shape with rounded corners 50, a horizontal rectangular shape with rounded corners 60, an inverted triangle with a right angle and curved hypotenuse shape 70 and an oval with a rounded off corner shape 80. The plurality of convected-shaped edge rear view mirrors 10 are not limited to these shapes and can be other shapes that are well known to those in the art.

FIG. 1B illustrates a side perspective view of a convected-shaped edge rear view mirror 10, in accordance with one embodiment of the present invention. Specifically, FIG. 1B illustrates a side perspective view of the horizontal rectangular shape with the rounded corners 60 embodiment of the convected-shaped edge rear view mirror 10. As mentioned previously in the FIG. 1A description, the curved outer and lower edges 15 provide a clear view to the rear side of a vehicle, into a blind spot and also at ground level that improves a driver's ability to see into an adjacent lane and prevent unnecessary sideswiping accidents from occurring and that is especially useful when changing lanes and merging into busy traffic on highways and other roadways. The curved and outer and lower edges 15 are provided on all embodiments of the convected-shaped edge rear view mirror 10. The curved outer and lower edges 15 are convected between a range of a 1 to 10 ratio and a 1 to 3 ratio.

The convect-shaped edge rear view mirror 10 could be neatly integrated into the design of new production vehicles and installed and retrofitted in place of traditional left and right external mirrors. It would be used primarily in conjunction with automobiles and light-duty trucks, but also made available for other types of vehicles like buses, RV's, semi-trucks, and even motorcycles. While ideal for production vehicles, the convect-shaped edge rear view mirror 10 could also be installed as a complete mirror replacement on aftermarket vehicles.

The convect-shaped edge rear view mirror 10 would measure approximately 4 to 6 inches tall and 4 to 10 inches long. The size, color, and styling of the mirror housing could vary significantly according to the particular vehicle application. Each convect-shaped edge rear view mirror housing that would be fitted with a flat-glass reflective panel section 90 that was curved forward along the outermost vertical edge 100 and also along the bottom horizontal edge 110 of the curved outer and lower edges 15. The primary flat glass section 90 would provide the standard rear side view, while the curved outer and lower edges 15 provided an expanded field of vision. The one-piece mirror design of the convect-shaped edge rear view mirror 10 would be adjustable with standard motorized controls (not shown) as well.

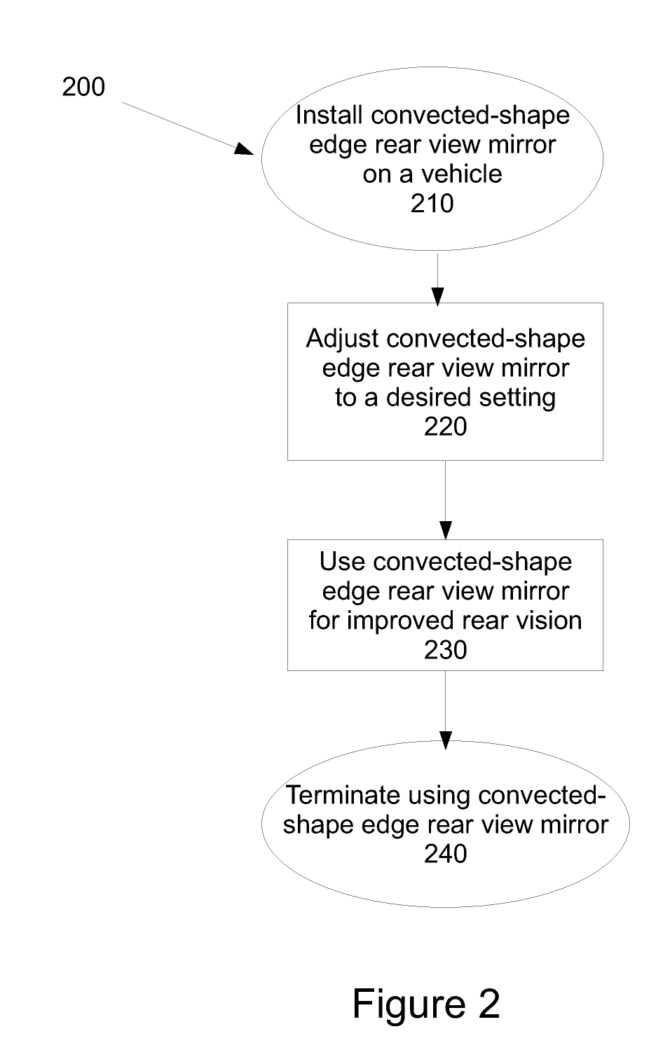

FIG. 2 illustrates steps of a method of using a convected-shaped edge rear view mirror 200, in accordance with one embodiment of the present invention. The steps of the method include installing a convected-shape edge rear view mirror on a vehicle 210, adjusting the convected-shape edge rear view mirror to a desired setting 220, using the convected-shape edge rear view mirror for improved rear vision 230 and terminating use of the convected-shape edge rear view mirror 240. Installing the convected-shape edge rear view mirror on a vehicle 210 can be done by any method that is well known to those in the art. Adjusting the convected-shape edge rear view mirror to a desired setting 220 involves a user adjusting the convected-shape edge rear view mirror so that a clear view to the rear side of a vehicle, into a blind spot and also at ground level that improves a driver's ability to see into an adjacent lane and prevent unnecessary sideswiping accidents from occurring and that is especially useful when changing lanes and merging into busy traffic on highways and other roadways is provided by the convected-shape edge rear view mirror. The desired setting will also be driver specific as each driver or user can adjust the convected-shape edge rear view mirror to their own height and eye-level.

Using a convected-shape edge rear view mirror for improved rear vision 230 requires that a user actually use the convected-shape edge rear view mirror when looking rearwardly. Terminating use of the convected-shape edge rear view mirror 240 involves the user simply not using the convected-shape edge rear view mirror because they don't need to view rearwardly or are not driving a vehicle that uses the convected-shape edge rear view mirror.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A rear view mirror provided on a vehicle, comprising:
a flat glass reflective panel section;
a plurality of convect-shaped curved outer and lower edges disposed onto flat glass reflective panel section said that provide a clear view to a rear side of said vehicle, into a blind spot and at ground level; and
a convect-shaped edge rear view mirror housing that is fitted with said flat-glass reflective panel section that is curved forward along said curved outer and lower edges.

2. The mirror according to claim 1, wherein said rear view mirror includes a general oval shape, a triangle with a right angle and curved hypotenuse shape, an oval shape with a rounded off side, an upright vertical rectangular shape with rounded corners, a horizontal rectangular shape with rounded corners, an inverted triangle with a right angle and curved hypotenuse shape and an oval with a rounded off corner shape.

3. The mirror according to claim 1, wherein said vehicle is an automobile, a truck, a bus, a recreational vehicle, a semi-truck or a motorcycle.

4. The mirror according to claim 1, wherein said rear view mirror is integrated into a new production vehicle.

5. The mirror according to claim 1, wherein said rear view mirror is installed and retrofitted in place of a traditional left and right external rear view mirror.

6. The mirror according to claim 1, wherein said curved outer and lower edges provide an expanded field of vision.

7. The mirror according to claim 1, wherein said curved outer and lower edges are convected between a range of a 1 to 10 ratio and a 1 to 3 ratio.

8. The mirror according to claim 1, wherein said rear view mirror is adjustable with standard motorized controls.

9. A rear view mirror provided as a complete rear view mirror replacement on an aftermarket vehicle, comprising:
a flat glass reflective panel section;
a plurality of convect-shaped curved outer and lower edges disposed onto flat glass reflective panel section said that provide a clear view to a rear side of said vehicle, into a blind spot and at ground level; and
a convect-shaped edge rear view mirror housing that is fitted with said flat-glass reflective panel section that is curved forward along said curved outer and lower edges.

10. The mirror according to claim 9, wherein said rear view mirror includes a general oval shape, a triangle with a right angle and curved hypotenuse shape, an oval shape with a rounded off side, an upright vertical rectangular shape with rounded corners, a horizontal rectangular shape with rounded corners, an inverted triangle with a right angle and curved hypotenuse shape and an oval with a rounded off corner shape.

11. The mirror according to claim 9, wherein said vehicle is an automobile, a truck, a bus, a recreational vehicle, a semi-truck or a motorcycle.

12. The mirror according to claim 9, wherein said rear view mirror is integrated into a new production vehicle.

13. The mirror according to claim 9, wherein said rear view mirror is installed and retrofitted in place of a traditional left and right external rear view mirror.

14. The mirror according to claim 9, wherein said curved outer and lower edges provide an expanded field of vision.

15. The mirror according to claim 9, wherein said curved outer and lower edges are convected between a range of a 1 to 10 ratio and a 1 to 3 ratio.

16. The mirror according to claim 9, wherein said rear view mirror is adjustable with standard motorized controls.

17. A method of using a convected-shape edge rear view mirror, comprising:
installing said convected-shape edge rear view mirror on a vehicle;
adjusting said convected-shape edge rear view mirror to a desired setting;
using said convected-shape edge rear view mirror for improved rear vision; and
terminating use of said convected-shape edge rear view mirror.

18. The method according to claim 17, wherein said desired setting is driver specific to a driver and is adjustable to said driver's height and eye-level.

19. The method according to claim 17, wherein said terminating use of said convected-shape edge rear view mirror includes without needing to view rearwardly while driving.

20. The method according to claim 1, wherein terminating use of said convected-shape edge rear view mirror includes not driving a vehicle that uses the convected-shape edge rear view mirror.
